(19) United States
(12) Patent Application Publication
(10) Pub. No.: US 2005/0071227 A1
(43) Pub. Date: Mar. 31, 2005

(54) Method and system for managing concurrent sku-based rewards program

(75) Inventors: Ayman Hammad, Pleasanton, CA (US); Loc Nguyen, San Francisco, CA (US); Liane Redford, San Mateo, CA (US); Gary Yamamura, Escondido, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Visa U.S.A., San Francisco, CA (US)

(21) Appl. No.: 10/676,848

(22) Filed: Sep. 30, 2003

(51) Int. Cl. G06F 17/60

(52) U.S. Cl. 705/14

(57) ABSTRACT

Techniques for providing a plurality of incentives for a product during a loyalty transaction are provided. A group of eligible incentives for a product are determined and one or more of the eligible incentives are selected and applied to the loyalty transaction. The techniques include determining a plurality of incentives that are eligible for application to the transaction, the eligibility based on at least one product; determining one or more incentives from the plurality of incentives to apply to the transaction; and applying the determined one or more incentives to the transaction.

### BACKGROUND OF THE INVENTION

The present invention generally relates to loyalty programs and more specifically to methods and apparatus for providing a plurality of incentives based on the same product during the same time period.

Loyalty programs provide users with incentives to shop at certain merchants participating in the loyalty programs. Typically, users are awarded incentives when they shop at the merchants participating in a particular loyalty program. An incentive is something of value that can be redeemed.

Typically, when an incentive for a product is offered by a sponsor, another incentive for the same product during the same time period cannot be offered. Multiple offers for the same product create conflicts that require complex decisions about how and what to redeem when there exists more than one outcome based upon the user's basket of products purchased and what incentive the user desires from the choice of incentives provided by multiple offers. The sponsor does not know what the user's choice would be at any given time for any given purchase. Thus, in order to avoid conflicts, sponsors generally limit their offering only one incentive for a product during the same time period. However, in some cases, sponsors may issue multiple paper coupons for a product. During a transaction, the decision to apply which one of the coupons is arbitrarily decided by a clerk. Thus, user dissatisfaction may occur because the decision is made without considering what is best for the user.

A loyalty program administrator avoids the problem by ensuring that only one incentive will apply for a single product in a loyalty transaction during the same time period. By only offering one incentive per product, the value of offering incentives for purchase behavior is decreased because different users may respond to different incentives. Thus, it is possible that only some users will be enticed to purchase a product because of an incentive and others would respond to another incentive (with a different offer) and will not be as inclined to purchase the product. Because of the limitations of offering one incentive per product, the incentives cannot be changed or tailored to satisfy different user desires or used to test multiple offers against each other concurrently to be able to evaluate which is the most effective incentive. Also, once a first incentive is offered for a product, sponsors that would like to offer an incentive for the same product during the same time period cannot do so until the first incentive is revoked or expires.

Accordingly, apparatus and methods for offering multiple incentives for a product are desired.

### BRIEF SUMMARY OF THE INVENTION

Embodiments of the present invention relate to providing a plurality of incentives for a product during a loyalty transaction. A group of eligible incentives for a product are determined and one or more of the eligible incentives are selected and applied to the loyalty transaction.

In one embodiment, a method for determining one or more incentives to apply to a transaction is provided. The method comprises: determining a plurality of incentives that are eligible for application to the transaction, the eligibility based on at least one product; determining one or more incentives from the plurality of incentives to apply to the transaction; and applying the determined one or more incentives to the transaction.

In another embodiment, a method for managing incentives in connection with a loyalty transaction is provided. The method comprises: determining a plurality of incentives that are eligible for the loyalty transaction, the eligibility determined based on at least one product; calculating an incentive value for each of the plurality of incentives; determining one or more incentives from the plurality of incentives to apply to the loyalty transaction based on the calculated incentive values for each of the plurality of incentives; and applying the determined one or more incentives to the loyalty transaction.

In yet another embodiment, a method for determining one or more incentives to apply to a loyalty transaction is provided. The method comprises: communicating with a portable device to conduct the loyalty transaction, the loyalty transaction involving at least one product having a product identifier; determining portable device information for the portable device; determining a plurality of incentives that are eligible for the loyalty transaction, the eligible incentives determined based on the product identifier and the portable device information; determining one or more incentives from the plurality of incentives to apply to the loyalty transaction; and applying the determined one or more incentives to the loyalty transaction.

In another embodiment, a method for managing a plurality of incentives is provided. The method comprises: determining information for the plurality of incentives, the information for each incentive including a product identifier; determining one or more rules for applying incentives if two or more incentives in the plurality of incentives are applicable for a loyalty transaction; and sending the information and the one or more rules to one or more distribution channels, wherein the information including the product identifier is usable to determine two or more eligible incentives from the plurality of incentives for the loyalty transaction and the one or more rules are usable to determine one or more incentives from the two or more eligible incentives that are applicable for the loyalty transaction.

In another embodiment, a method for determining one or more incentives to apply to a loyalty transaction is provided. The method comprises: using a portable device in a loyalty transaction for at least one product associated with a product identifier; determining loyalty program information for a plurality of loyalty programs; determining portable device information for the portable device; determining transaction details for the loyalty transaction; determining one or more incentives from a plurality of incentives to apply to the loyalty transaction based on at least one of the loyalty program information, portable device information, product identifier, and transaction details, wherein the plurality of incentives are associated with the product identifier; and applying the determined one or more incentives to the loyalty transaction.

In another embodiment, a device for determining one or more incentives to apply to a loyalty transaction is provided. The device comprises: a communicator configured to receive a request to process a loyalty transaction involving at least one product; a program determiner configured to determine a plurality of incentives that are eligible for application to the loyalty transaction, the eligibility based on the at least one product; an incentive selector configured to select one or more incentives from the plurality of incentives to apply to the loyalty transaction; and an incentive applier configured to apply the determined one or more incentives to the loyalty transaction.

In another embodiment, a system for determining one or more incentives to apply to a loyalty transaction is provided. The system comprises: one or more portable devices, each portable device including portable device information; and one or more distribution channels, at least one distribution channel comprising: a communicator configured to communicate with a portable device in the one or more portable devices for a loyalty transaction involving at least one product and to determine portable device information associated with the portable device; an incentive selector configured to determine one or more incentives from a plurality of incentives associated with the at least one product to apply to the loyalty transaction, the one or more incentives determined based on the at least one product and the portable device information; and an incentive applier configured to apply the determined one or more incentives to the loyalty transaction.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE DRAWINGS

FIG. 1 illustrates a system for providing loyalty programs according to one embodiment of the present invention;

FIG. 2 illustrates a system depicting a loyalty transaction between a portable device and a distribution channel according to one embodiment of the invention;

FIG. 3 illustrates a simplified flowchart for distributing information to selected distribution channels according to one embodiment of the present invention;

FIG. 4 illustrates a simplified flowchart of a method for performing a loyalty transaction between a portable device and a distribution channel according to one embodiment of the present invention;

FIG. 5 illustrates a simplified flowchart of a method of determining one or more incentives from the plurality of eligible incentives for a loyalty transaction according to one embodiment of the present invention;

FIG. 6 illustrates the simplified flow chart of a method for processing a loyalty transaction eligible for multiple incentives according to one embodiment of the present invention;

FIG. 7 illustrates a simplified flowchart of a method for processing a loyalty transaction that is eligible for multiple incentives but does not have multiple incentives applied according to one embodiment of the present invention;

FIG. 8 illustrates a simplified flowchart of a method for processing a loyalty transaction that is not eligible for multiple incentives according to one embodiment of the present invention; and

FIG. 9 illustrates a simplified flowchart of a method for processing a loyalty transaction that may be eligible for multiple incentives where an incentive that expires first is applied to the transaction according to one embodiment of the present invention.

### DETAILED DESCRIPTION OF THE INVENTION

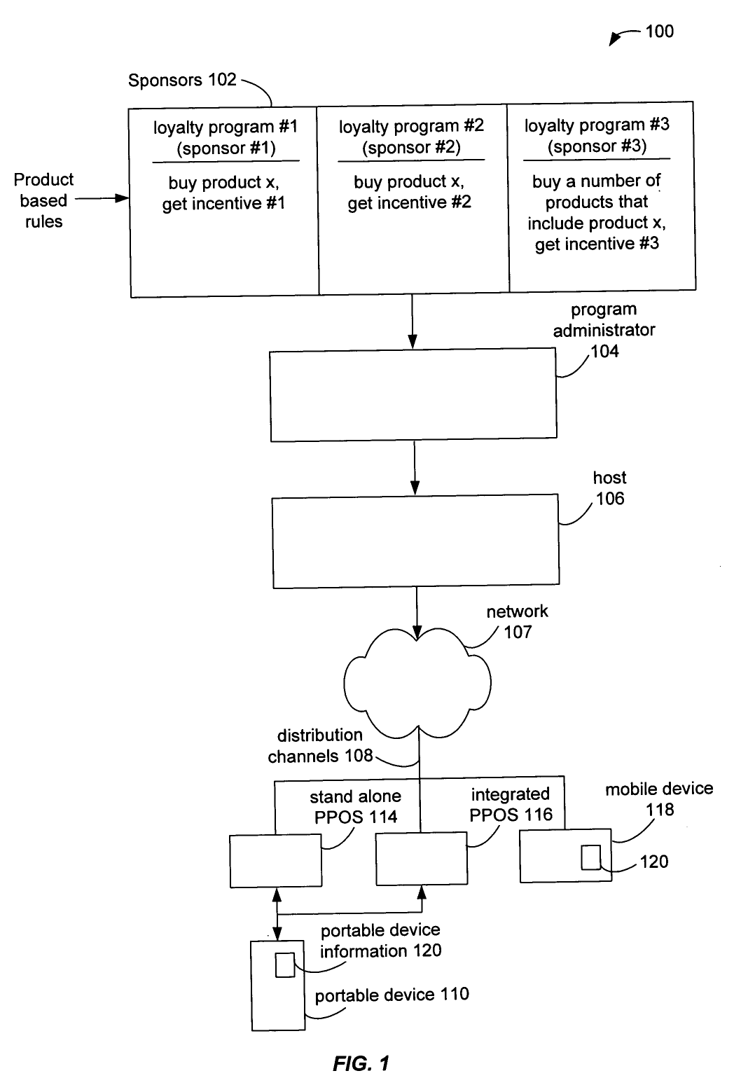

FIG. 1 illustrates a system 100 for providing loyalty programs according to one embodiment of the present invention. Multiple loyalty programs are defined for a specific product. As shown, loyalty programs #1-3 offer incentives #1-3 for the same product X.

One or more sponsors 102 are providers of prizes and incentives for loyalty programs. Sponsors 102 are any entities, such as product manufacturers, that can sponsor a loyalty program. Sponsors 102 typically define the parameters of how a loyalty program is provided. This information may include the incentives that are awarded, the requirements that define whether an incentive should be rewarded, the eligible participants, and the products or actions that will invoke an incentive when purchased.

Once sponsors 102 define a respective loyalty program, a program administrator 104 receives the information for the loyalty programs and translates the information into a format readable by a host 106. The translated information is outputted to host 106.

Host 106 is a central administrator of all loyalty programs for system 100. Host 106 receives the information from program administrator 104 and can selectively download the information through a network 107 to a plurality of distribution channels 108.

Network 107 may be any network, such as the Internet, a wireless network, a wire line network, a local area network (LAN), a wide area network (WAN), and the like. In one embodiment, the loyalty parameter may be selectively downloaded to certain distribution channels 108. For example, loyalty programs may be downloaded to applicable distribution channels 108 that will be offering the loyalty program.

Distribution channels 108 include any device capable of performing a loyalty transaction. In one embodiment, distribution channels 108 include a standalone physical point of sale (PPOS) device 114, an integrated physical point of sale device 116, and a mobile device 118. Distribution channels 108 may perform loyalty transactions offline. In one embodiment, offline indicates that distribution channel 108 does not need to communicate with host 104 to perform the loyalty transaction or to determine eligible incentives for a loyalty transaction. Distribution channel 108 may, however, communicate with host 104 for other reasons, such as for reporting results of transactions, etc.

Stand alone PPOS 114 is a stand alone device dedicated to performing point of sale transactions. For example, PPOS 114 includes a point of sale or acceptance point device that may perform loyalty transactions. Point of sale devices found in merchants' stores are examples of stand alone PPOS devices 114.

Integrated PPOS 116 may be a point of sale or acceptance point device that has been integrated into another device, such as a computer. For example, integrated PPOS 116 may be an application on the World Wide Web (WWW) accessed through a computing device over the Internet. A website for shopping on the Internet and a card acceptance device may be an example of PPOS 116.

Mobile devices 118 include any mobile devices, such as cellular phones, personal digital assistants (PDA), pocket personal computers (PCs), laptop computers, tablet computers, etc. One difference between mobile devices 118 and PPOS devices 114 and 116 is that PPOS devices 114 and 116 communicate with a portable device 110 in order to enable a loyalty transaction. Mobile devices 118, however, do not need to communicate with portable device 110 because mobile devices 118 are a portable device 110 and may also perform the functions of distribution channel 108 together.

Portable devices 110 are devices that are used by loyalty program participants to conduct loyalty transactions. For example, portable devices 110 include smartcards, cellular phones, personal digital assistants (PDAs), pagers, payment cards, security cards, access cards, smart media, transponders, and the like. Each portable device 106 includes a module, such as a computer chip with dedicated hardware, software, embedded software, or any combination thereof, that is used to perform actions associated with loyalty transactions.

Portable devices 110 include portable device information 120. Similarly, mobile devices 118 also include portable device information 120. Portable device information 120 includes any information that uniquely identifies either portable device 110 or mobile device 118. For example, portable device information 120 may be an identifier, a unique ID, a serial number, an account number, etc. Thus, a user that is associated with portable device 110 or mobile device 118 may be uniquely identified using portable device information 120. Also, portable device information 120 includes any other information related to a loyalty transaction, such as information for which loyalty programs portable device 110 is eligible for.

A transaction is typically performed between portable device 110 and stand alone PPOS 114 or integrated PPOS 116. In another embodiment, mobile devices 118 may participate in a loyalty transaction. In this case, mobile device 118 performs the transaction with a stand alone PPOS 114, an integrated PPOS 116 or a host 106, where host 106 performs the functionality of stand alone PPOS 114 or integrated PPOS 116. For discussion and illustrative purposes, it will be described that a transaction is being performed between portable device 110 and distribution channel 108. It should be understood, however, that the transaction may be between portable device 110 and PPOS 114 and/or 116, or mobile devices 118 and host 106.

A transaction between portable device 110 and distribution channel 108 may be a loyalty transaction under a loyalty program. For example, a loyalty transaction is where a user of portable device 110 is purchasing items that qualify the user and portable device 110 for one or more incentives or rewards in the loyalty program. Incentives or rewards offer something of value for a user.

As shown, one or more sponsors 102 sponsor a plurality of loyalty programs. A loyalty program #1 from a sponsor #1 provides a program of buy product X and get an incentive #1, a loyalty program #2 from a sponsor #2 provides a loyalty program of buy product X and get an incentive #2, and a loyalty program #3 from a sponsor #3 provides a program of buy a number of products that include product X and get an incentive #3. For example, incentive #1 may be get 10% off of the price of product X, incentive #2 may be get a free toothbrush, and incentive #3 may be get 20% off the total price of the transaction. Although it is described that there are multiple loyalty programs, it should be understood that any number of loyalty programs may offer multiple incentives for a single product and that there may not be multiple loyalty programs. Also, although it is described that there are multiple sponsors, it should be understood that any number of sponsors may offer multiple incentives for a single product and that there may not be multiple sponsors.

If a product X is purchased in a loyalty transaction, all three incentives may be eligible for redemption as an incentive. System 100 then determines which incentives to award from the incentives where it is possible to apply one or more incentives for the loyalty transaction. The process for determining eligible incentives to apply to a loyalty transaction will be described in more detail below.

In one embodiment, sponsors 102 define product identifiers that may be used to decide which incentives to apply to the loyalty transaction. For example, a product identifier may be a storage keeping unit (SKU), bar code, or any other identifier that can identify a product. In one embodiment, when a product is purchased in a loyalty transaction, the product identifier is used to determine the eligible incentives. The product identifier may be determined using a scanner, bar code scanner, keyboard, etc. Incentives to apply to the loyalty transaction are then determined based on the identifier and possibly other information associated with the transaction as will be described later.

In one embodiment, program administrator 104 may save information in one or more data fields in loyalty program parameters for a loyalty program. The data fields may be variable and changed to reflect changes to the loyalty program. The loyalty program parameters define how a loyalty program will be provided (i.e., start date, products, end date, who is eligible, product identifiers, etc.). In one embodiment, the data fields may indicate rules or factors that are used to determine which incentives to apply to a loyalty transaction that is eligible for multiple incentives. The data fields may indicate an order of precedence for redemption of multiple, concurrent incentives or indicate that a user may select one or more incentives for redemption. Also, a data field may define specific circumstances when certain incentives will override instructions dictated by the other data fields in order to ensure compliance with legal or contractual requirements. Additionally, the data fields may include a field that indicates whether a specific incentive redemption can be combined with another incentive when multiple incentives are invoked by a single loyalty transaction.

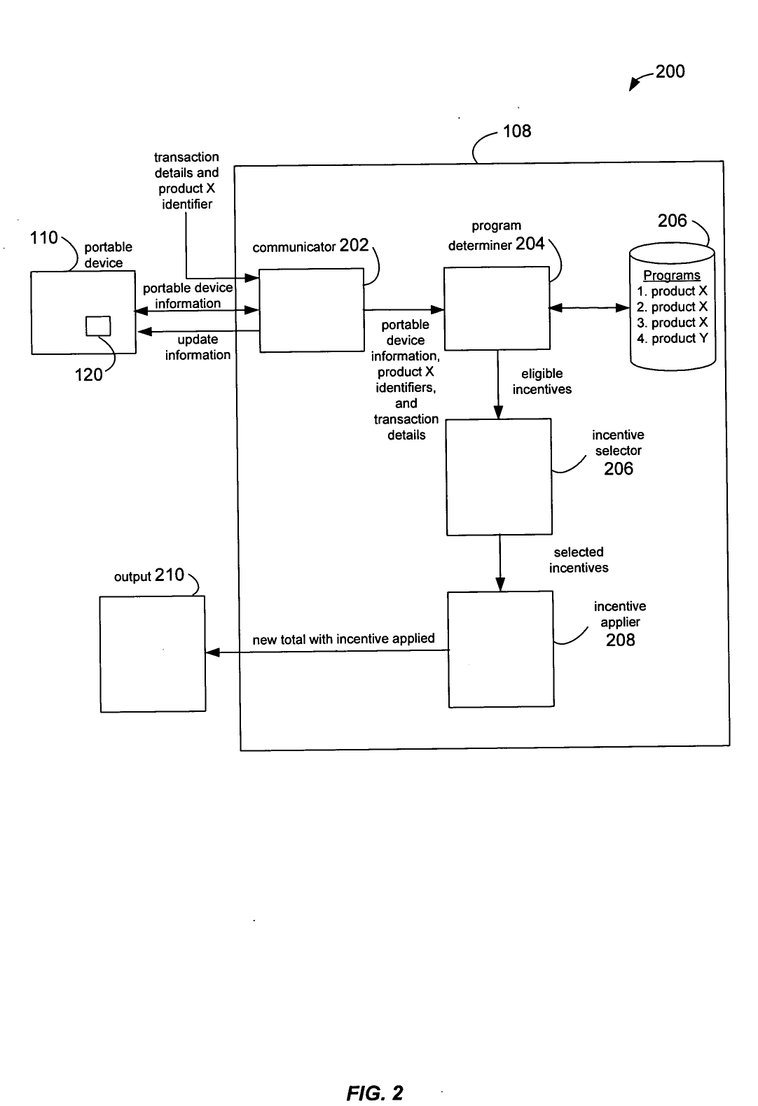

FIG. 2 illustrates a system 200 depicting a loyalty transaction between a portable device 110 and a distribution channel 108 according to one embodiment of the invention. Portable device 110 and distribution channel 108 communicate for a loyalty transaction where a product X is being purchased by a user of portable device 110. Distribution channel 108 includes a loyalty application depicted as a communicator 202, a program determiner 204, an incentive selector 206, and an incentive applier 208.

Communicator 202 is configured to communicate with portable device 110 to determine portable device information 120. In one embodiment, communicator 202 may communicate with a card acceptance device (CAD), which is configured to allow communicator 202 to communicate with portable device 110.

Communicator 202 is also configured to determine an identifier for the product X and transaction details. The identifier may be determined by scanning a bar code or SKU associated with product X. Additionally, other ways of determining the product identifier may be used, such as a user inputting the identifier using a keypad. The transaction details may be determined by an electronic cash register (ECR) and include information about the transaction. For example, the transaction details include the items purchased, price of the products, and total value of the transaction.

Program determiner 204 receives portable device information 120, the product X identifier, and transaction details from communicator 202 and outputs eligible incentives for the loyalty transaction with portable device 110. In one embodiment, eligible incentives are the incentives that are available to portable device 110 based on the product purchased. For example, portable device 110 may be eligible for an accumulation towards an eligible incentive or redemption of an eligible incentive because a product X was purchased. Also, the incentives may be offered by one or more sponsors 112 for one or more loyalty programs. For example, portable device 110 may be eligible for the incentives associated with loyalty programs #1-3.

Program determiner 204 determines which incentives are eligible for the loyalty transaction. In one embodiment, program determiner 204 is configured to use any combination of the product X identifier, portable device information 120, loyalty program parameters, and the transaction details to determine the eligible incentives. For example, portable device information 120 may indicate that portable device 110 qualifies for a number of loyalty programs. In determining the eligible loyalty programs, program determiner 204 is configured to retrieve the loyalty program parameters for the eligible programs from database 206. The loyalty program parameters for each loyalty program are then used to determine the incentive that should be awarded. The parameters may indicate that an incentive is awarded if a product identifier corresponds to information in the parameters and an action is taken involving a product. For example, the incentive will be awarded if a user buys a certain product, agrees to test the product, etc.

Depending on the loyalty program parameters, product identifiers, and/or transaction details, portable device 110 may be eligible for any number of programs. For example, database 206 includes four loyalty programs, three for product X and one for product Y. If the first two are buy product X and receive an incentive, the third is buy product X along with purchasing a certain amount and receive an incentive, and the fourth is buy product Y and receive an incentive, transaction details and the product identifier may be used to determine that product X is being purchased and a certain total amount was purchased and thus portable device 110 is eligible for the first three programs.

The loyalty program parameters also indicate how to calculate the incentive. For example, the incentive may be receive 10% off a product, receive a product Y, or receive 20% off the total value of the transaction. The information may also include information for rules on how to determine which incentives to apply to a loyalty transaction if multiple incentives are eligible for the transaction.

Incentive selector 206 receives any combination of the loyalty program parameters for the eligible loyalty programs, portable device information 120, transaction details, and product X identifier and outputs selected incentives that should be applied to the loyalty transaction. Because multiple incentives can be eligible and awarded for a single product associated with a loyalty transaction, incentive selector 206 determines which combination of incentives should be applied.

In selecting the incentives, incentive selector 206 may use any combination of portable device information 120, loyalty parameters for the programs, transaction details, and any other information to determine which incentives to apply to the loyalty transaction. In one embodiment, the data fields found in the parameters for the loyalty programs may be used along with the transaction details to select incentives to apply to the loyalty transaction. The data fields may indicate certain rules that should be applied in selecting incentives. For example, a decision may be made based on the monetary value that each incentive offers upon redemption, based on the item that was purchased and a user preference, based on an expiration date, and based on if incentives allow combining.

If the incentives are selected based on monetary value, one or more incentives that reward the highest dollar value for the loyalty transaction may be selected. If incentives do not allow combining, one incentive may be chosen that provides the highest reward. If incentives do allow combining, then one or more incentives may be combined to generate the largest monetary reward that does not exceed a determined value, such as the value of product X or the total value of the transaction.

If the decision is based on a product and a user preference, the user may be given a choice between a number of incentives. For example, the user may choose between the incentives offered by loyalty programs #1-3. A message including a list of incentives may be output to a user and a choice of an incentive is received from the user as input.

If the decision is based on the expiration date, in one example, the incentive that has the nearest expiration date may be awarded for the transaction. This allows a user to redeem incentives that may be expiring in the nearest future thus allowing the user more time to redeem the other incentives.

If the decision is based on if incentives are combinable, any incentives may be combined if it is indicated that they can be combined. In one embodiment, incentives may be combined if the combined redemption value does not exceed a specified value, such as the price of the item or the total transaction value. In one example, the incentive with the highest redemption value is determined. It is then determined if that incentive allows combining with other incentives. The loyalty parameters for the incentive (e.g., information in the data fields) may be used to determine if combining is allowed. If combining is allowed, other incentives in the eligible incentives may be combined if they also allow combining. If the highest redemption value incentive does not allow combining, then the incentive is not combined with any other incentives in one embodiment.

Incentive applier 208 receives the selected incentives and transaction details from incentive selector 206 and outputs a new total for the transaction. In determining a new total for the transaction, incentive applier 208 uses the loyalty parameters to determine how the selected incentives should be applied. The parameters may indicate, for example, a first incentive of reduce a total for the transaction by 10% and a second incentive of disburse a free product Y. The total redemption value from the selected incentives is then calculated and applied to the original total from the original transaction details. If 10% off $5.00 is used, the total incentives yield a $1.00 discount and a $5.00 original total will be reduced to $4.00. A free product Y is also awarded.

The new total is then sent to an output 210, which outputs the new total for the loyalty transaction. Output 210 may be any output device that is configured to communicate with a user. For example, output 210 may be a display, a printer, a speaker that audibly announces the new total, and the like.

After the one or more incentives are applied or redeemed, communicator 202 may update portable device information 120 to indicate that the loyalty transaction has taken place. For example, the new information 120 may indicate that certain incentives were accumulated and redeemed.

Although it is described that only one product identifier is used, it should be understood that any number of product identifiers may be used in determining incentives to apply.

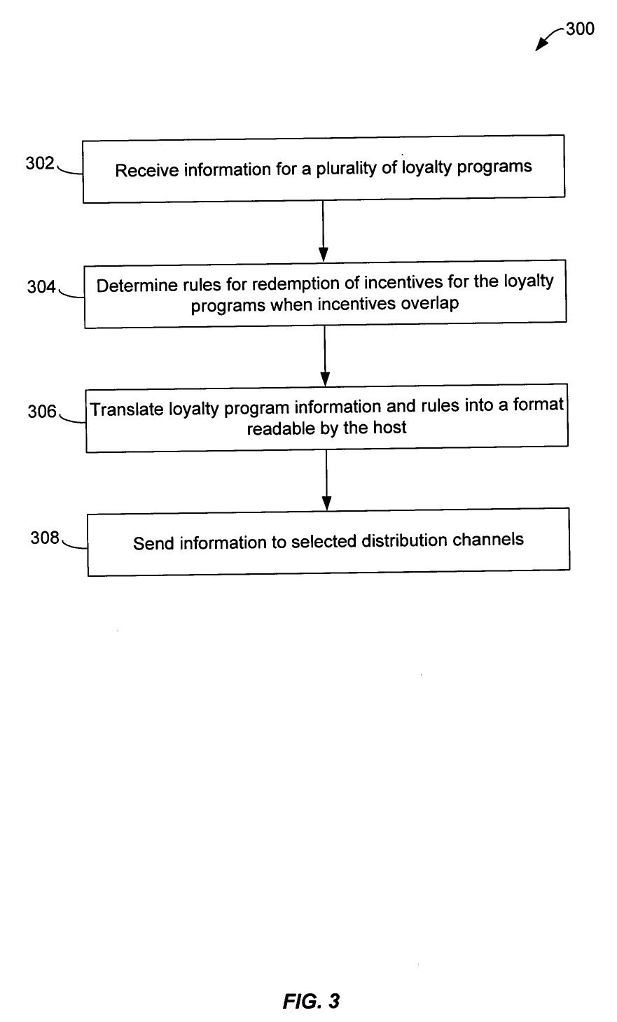

FIG. 3 illustrates a simplified flowchart 300 for distributing information to selected distribution channels 108 according to one embodiment of the present invention. In step 302, information is received for a plurality of loyalty programs from one or more sponsors 102. The information may specify actions that trigger an incentive for a loyalty program and the incentives that will be awarded. The parameters may also include a product identifier that identifies a product that is associated with the triggering action.

In step 304, rules for selecting incentives when concurrent incentives are selected for a loyalty transaction are determined. The rules may be determined from information specified by sponsors 102 or default rules may be used. Examples of some rules include rules based on the monetary value that each incentive offers upon redemption, based on the item that was purchased and a user preference, based on an expiration date, and based on if incentives allow combining as described above.

In step 306, the loyalty program information and rules are translated into a format readable by host 106. In one embodiment, the rules may be saved in one or more data fields for a loyalty program. For example, a combination of numbers in fields may be interpreted by distribution channel 108 as a rule, such as the incentive does not allow combining with other incentives, etc.

In step 308, host 106 downloads information for the loyalty programs to distribution channels 108. In one embodiment, the loyalty programs are selectively downloaded to certain distribution channels 108.

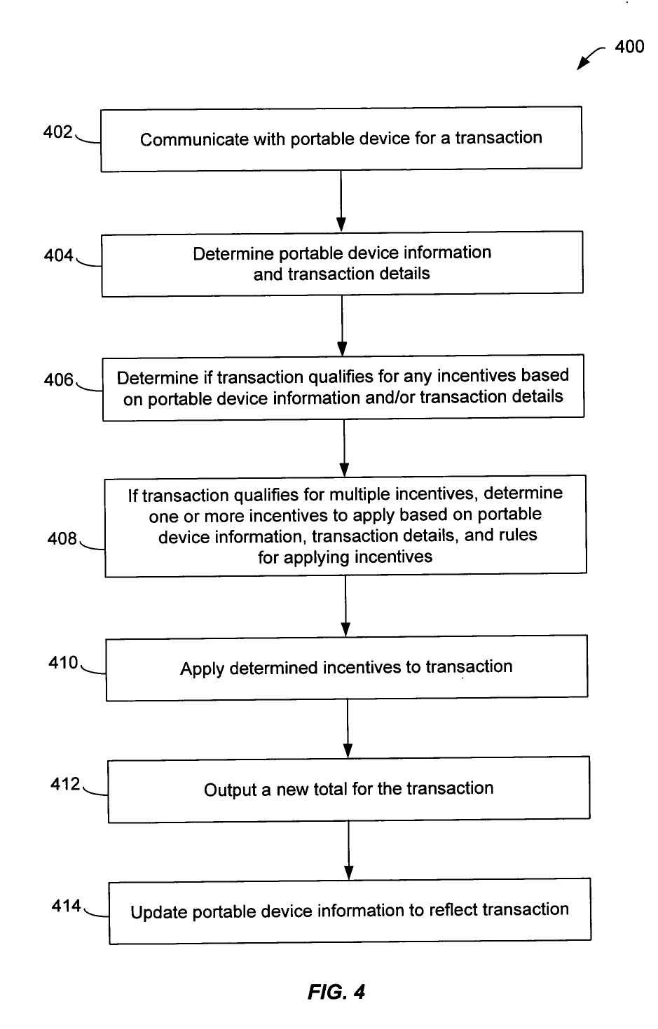

When information is downloaded to distribution channels 108, transactions between portable devices 110 and distribution channels 108 may be initiated. FIG. 4 illustrates a simplified flowchart 400 of a method for performing a loyalty transaction between a portable device 110 and a distribution channel 108 according to one embodiment of the present invention. In step 402, distribution channel 108 communicates with portable device 110 for a loyalty transaction. In a transaction, a user may be purchasing a number of products.

In step 404, distribution channel 108 determines any combination of portable device information 120, product identifiers, and transaction details. The transaction details include information on the products that are being purchased. For example, transaction details may include prices for the purchased products and a total value for the transaction. The product identifiers identify the products being purchased.

In step 406, distribution channel 108 determines if a transaction qualifies for any incentives based on any combination of the product identifiers, portable device information 120, and/or transaction details. These incentives may be all the incentives that are eligible for this transaction with portable device 110. The incentives may also be a subset of all the eligible incentives.

In step 408, if the transaction qualifies for multiple incentives, distribution channel 108 determines one or more incentives to apply based on any combination of portable device information 120, the transaction details, and rules for applying multiple incentives. For example, values in portable device information 120 are compared to values in the data fields of the loyalty parameters for the eligible incentives and the transaction details (e.g., dollar values of potential incentive redemptions) to determine the appropriate incentives to apply to the loyalty transaction. The rules discussed above may be used in selecting the incentives to apply.

In step 410, the selected incentives are applied to the transaction. For example, a new total value for the transaction is calculated based on the redeemed incentives.

In step 412, the new total for the transaction is outputted to the user and payment for the new total is received.

In step 414, portable device information 120 may be updated to reflect actions taken in the transaction. For example, an accumulation towards an incentive or a redemption is stored in portable device information 120.

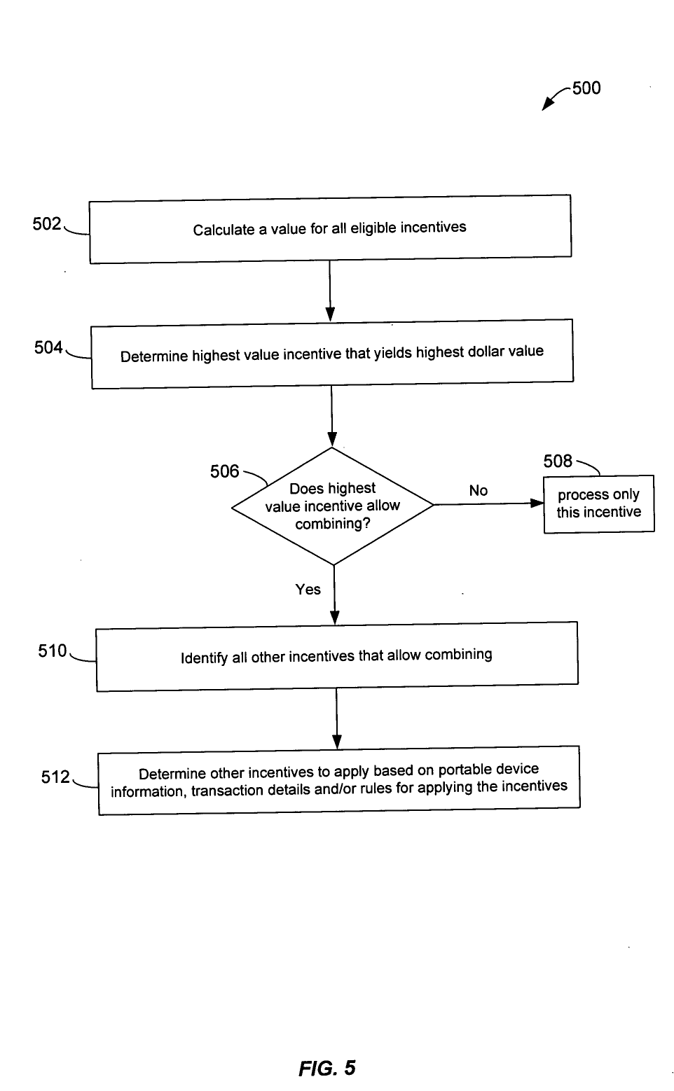

FIG. 5 illustrates an embodiment of determining one or more incentives from the plurality of eligible incentives for a loyalty transaction according to one embodiment of the present invention. In step 502, a value for all eligible incentives is calculated. For example, a dollar value of how much the incentives will be worth if applied to the loyalty transaction is calculated. If a free product is given away, the value of the product may be used.

In step 504, distribution channel 108 determines an incentive that has the highest redemption value. The highest value may be a discount on the total value, a value of a product given away, a value of a service provided, etc.

In step 506, distribution channel 108 determines if the highest value incentive allows combining. For example, a field in the loyalty parameters associated with the incentive may indicate whether or not the incentive may be combined with other incentives.

If the highest value incentive does not allow combining, distribution channel 108 processes only the highest value incentive in step 508.

If the highest value incentive does allow combining, in step 510, the other incentives that allow combining are identified. This eliminates other incentives of lower values that do not allow combining because they may not be combined with the highest value incentive.

In step 512, distribution channel 108 determines other incentives from the combinable incentives to apply based on any combination of portable device information 120, transaction details, and rules for applying the incentives. Any of the methods described above or below may be used to determine the incentives to combine with the highest value incentive. In one example, all incentives that allow combining may be combined as long as the redemption value does not exceed a specified amount, such as the value of the product associated with the product identifier or the total transaction value.

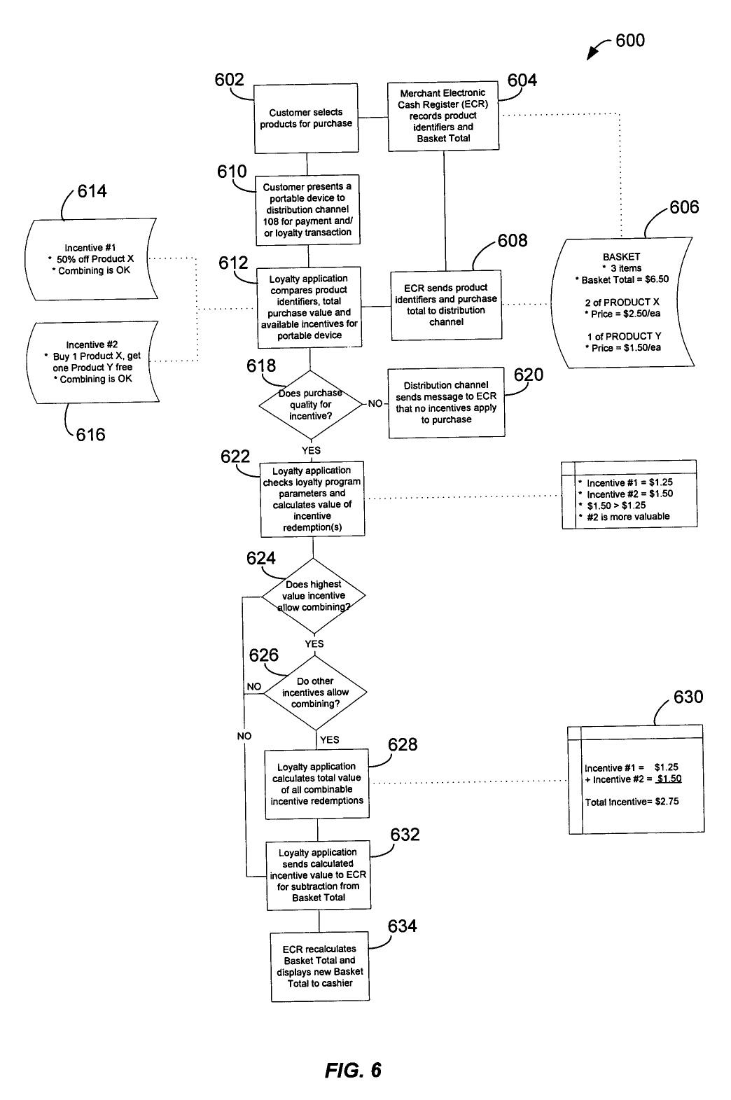

FIG. 6 illustrates the simplified flow chart 600 of a method for processing a loyalty transaction eligible for multiple incentives according to one embodiment of the present invention. In step 602, the user selects one or more products for purchase. The purchase transaction may be made at any distribution channel 108, such as at a stand alone PPOS 114, an integrated PPOS 116 or a mobile device 118. For discussion and illustrative purposes, it will be assumed that the user is purchasing products at a PPOS 114 or PPOS 116 using a portable device 110.

In step 604, a merchant electronic cash register (ECR) records product identifiers and a basket total. The product identifiers identify the products that are being purchased. For example, the ECR may record SKUs for the products. As shown in box 606, a basket total includes three items for a total of $6.50. Two units of product X were purchased at a price of $2.50 each and one item of product Y was purchased at a price of $1.50 each.

In step 608, the ECR sends the product identifiers and basket total to distribution channel 108.

In step 610, the user presents a portable device 110 to distribution channel 108 for payment and/or initiation of a loyalty transaction. In step 612, a loyalty application compares the product identifiers, the purchase value, and/or available incentives for portable device 110. As shown in box 614, an incentive #1 that offers 50% off a purchase of product X is determined and combining this incentive with other incentives is allowed. As shown in a box 616, an incentive #2 of buy one item of product X and get one item of product Y free is determined and combining this incentive with other incentives is allowed. It will be understood that processing between distribution channel 108 and portable device 110 may occur to determine the incentives. For example, portable device information 120 and loyalty program parameters may be used to determine the available incentives for portable device 110.

In step 618, a loyalty application determines if the purchase qualifies for an incentive. If the purchase does not qualify for an incentive, in step 620, distribution channel 108 sends a message to the ECR that no rewards apply to the purchase. A purchase may continue and accumulation in some circumstances may occur, but no incentives will be applied to the purchase.

In step 622, a loyalty application checks loyalty program parameters and calculates the redemption values. As shown in box 624, incentive #1 yields a redemption value of $1.25 and incentive #2 yields a redemption value of $1.50. The value of incentive #1 ($1.50) is greater than incentive #2 ($1.25) and thus incentive #1 is deemed to be more valuable.

In step 624, the loyalty application determines if the highest value incentive allows combining. If the highest value incentive allows combining, in step 626, it is determined if other incentives allow combining. If other incentives allow combining, in step 628, the loyalty application calculates a total value of all combinable incentive redemptions. Other factors may be considered while calculating the total value of all combinable incentive redemptions, such as not allowing the total incentive redemption to be more than a basket total or a price of a product. As shown in box 630, an incentive #1 plus incentive #2 equals a total incentive value of $2.75.

If either the highest value incentive does not allow combining in step 624 or if the highest value incentive allows combining but other incentives do not allow combining in step 626, the process proceeds to step 632 and does not calculate a total value of all combinable incentives.

In step 632, the loyalty application sends the calculated incentive value to the ECR for subtraction from the basket total. In step 634, the ECR recalculates the basket total and displays the new basket total to the cashier.

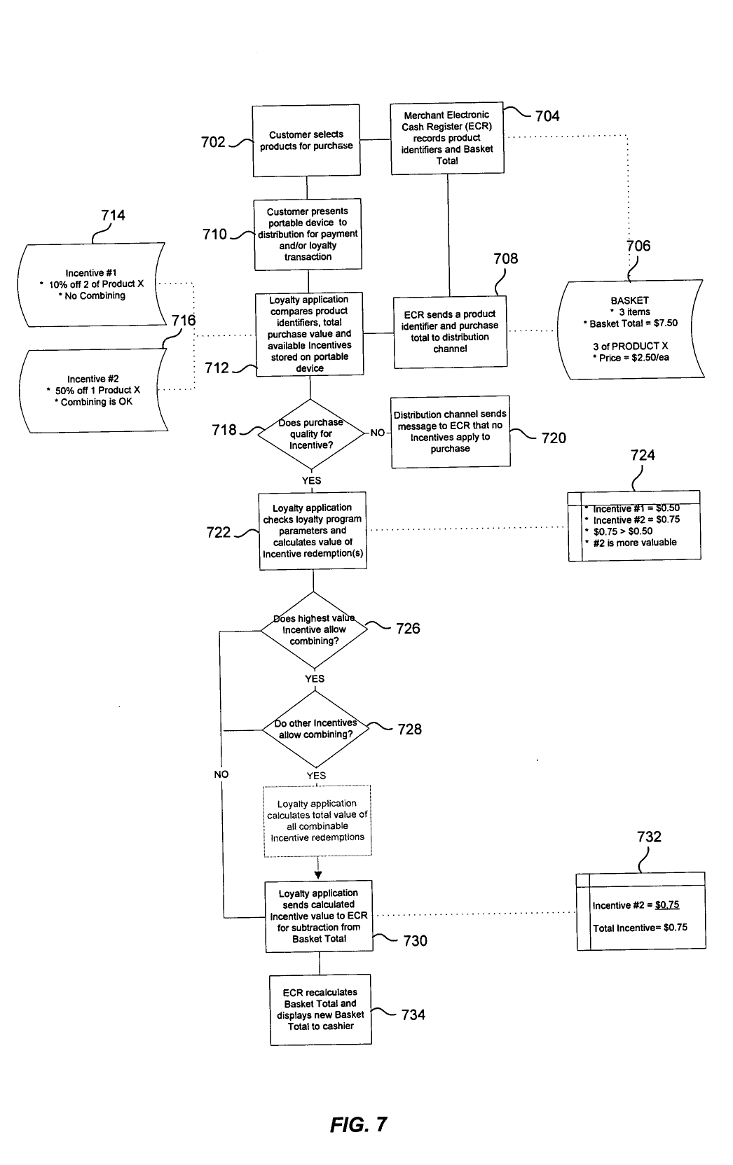

FIG. 7 illustrates a simplified flowchart 700 of a method for processing a loyalty transaction that is eligible for multiple incentives but does not have multiple incentives applied according to one embodiment of the present invention. In step 702, the user selects products for purchase. In step 704, a merchant electronic cash register (ECR) records product identifiers and a basket total. Box 706 indicates a basket total of $7.50 with the purchase of three items of a product X at a price of $2.50 each.

In step 708, the ECR sends a product identifier and a purchase total to a distribution channel 108. In step 710, the user presents a portable device 110 to distribution channel 108 for payment and/or a loyalty transaction.

In step 712, a loyalty application compares the product identifiers, the purchase value, and/or available incentives for portable device 110. As shown in box 714, an incentive #1 of 10% off two items of product X is determined with no combining allowed. As shown in a box 716, incentive #2 of 50% off one item of product X is determined with combining allowed. It will be understood that processing between distribution channel 108 and portable device 110 may occur to determine the incentives. Portable device information 120 and loyalty program parameters may be used to determine the available incentives for portable device 110.

In step 718, a loyalty application determines if the purchase qualifies for an incentive. If the purchase does not qualify for an incentive, distribution channel 108 sends a message to the ECR that no incentives apply to the purchase. A purchase may continue as a loyalty transaction where an accumulation is made but no incentives will apply to the purchase.

In step 722, the loyalty application checks loyalty program parameters and calculates a value of the incentive redemptions. As shown in box 724, an incentive #1 yields a redemption value of $0.50 and an incentive #2 yields a redemption value of $0.75. It is determined that incentive #2 is the more valuable incentive.

In step 726, the process determines if the highest value incentive allows combining. If the highest value incentive does not allow combining, the process proceeds to step 730 without combining any incentives. In this case, the highest value incentive does allow combining and in step 728, the loyalty application determines if other incentives allow combining. In this case, incentive #1 does not allow combining, so the process proceeds to step 730. No other incentives were combined with incentive #2 but if incentive #1 had allowed combining, it could have been combined with incentive #2.

In step 730, a loyalty application sends a calculated incentive value to the ECR for subtraction from the basket total. As shown in box 732, incentive #2 of $0.75 is calculated for a total incentive of $0.75.

In step 734, the ECR recalculates the basket total and displays a new basket total to the cashier.

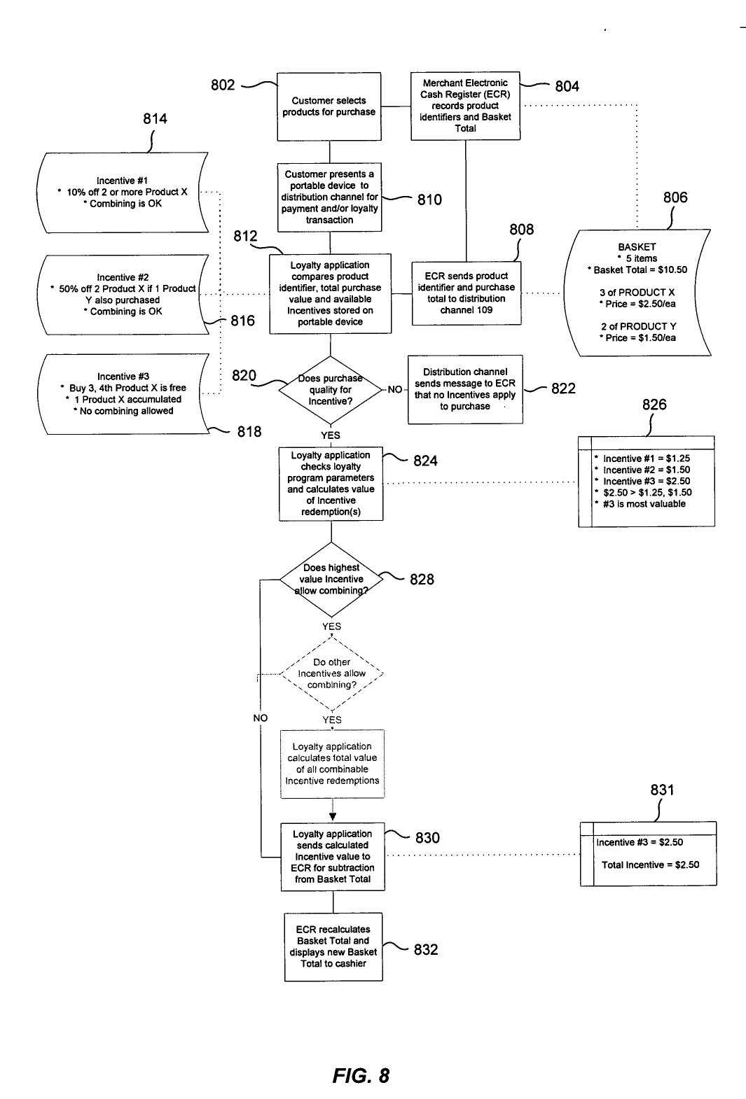

FIG. 8 illustrates a simplified flowchart 800 of a method for processing a loyalty transaction that is not eligible for multiple incentives according to one embodiment of the present invention. In step 802, a user selects products for purchase. In step 804, a merchant electronic cash register (ECR) records product identifiers in a basket total. As shown in box 806, a basket includes five items for a basket total of $10.50 where three items of a product X were purchased at a price of $2.50 each and two items of a product Y were purchased at a price of $1.50 each. In step 808, the ECR sends the product identifiers and purchase total to distribution channel 108.

In step 810, a user presents a portable device 110 to distribution channel 108 for a payment and/or loyalty transaction.

In step 812, a loyalty application compares the product identifiers, the purchase value, and/or available incentives for portable device 110. As shown in box 814, an incentive #1 of 10% off two or more items of product X is determined and combining is allowed. In box 816, an incentive #2 of 50% off two items of product X if one item of product Y is purchased is determined and combining is allowed. In box 818, an incentive #3 is determined where a fourth item of product X is free if three items of product X are bought. It also indicates that one free product X has been accumulated and that no combining is allowed. In this case, the accumulation of one free item of product X may have triggered the changing of the incentive from combining is allowed to no combining is allowed. This information would have been written into portable device 120 when the redemption occurred.

In step 820, the loyalty application determines if the purchase qualifies for an incentive. In step 822, if the purchase does not qualify for an incentive, the distribution channel 108 sends a message to the ECR that no incentives apply to the purchase.

In this case, the purchase does qualify for the incentive, and in step 824, the loyalty application checks loyalty program parameters and calculates a value for the incentive redemptions. In box 826, an incentive #1 has a redemption value of $1.25, an incentive #2 has a redemption value of $1.50, and an incentive #3 has a redemption value of $2.50. Hence, based on redemption value, incentive #3 is deemed the most valuable.

In step 828, the loyalty application determines if the highest value incentive allows combining. In this case, the highest value incentive does not allow combining and thus determining if other incentives can be combined with the highest value incentive is not performed.

In step 830, the loyalty application sends a calculated incentive value to the ECR for subtraction from the basket total. As shown in a box 831, a reward of $2.50 is calculated. In step 832, the ECR recalculates the basket total and the new basket total is displayed to a cashier.

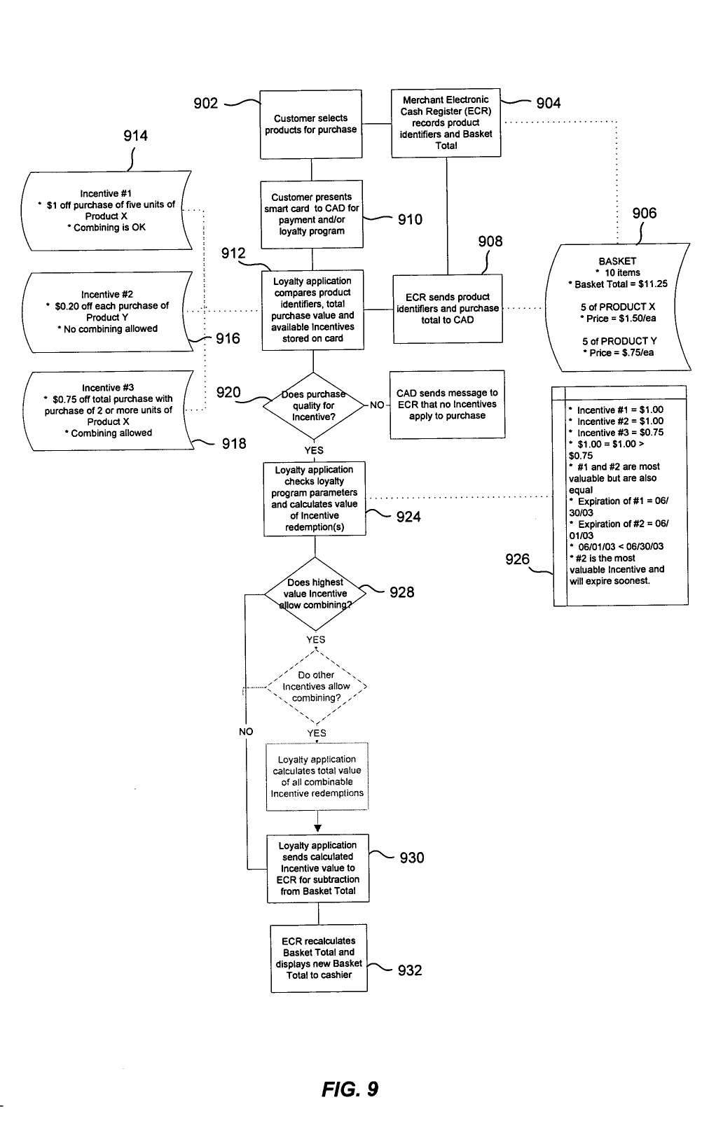

FIG. 9 illustrates a simplified flowchart 900 of a method for processing a loyalty transaction that may be eligible for multiple incentives where an incentive that expires first is applied to the transaction according to one embodiment of the present invention. In step 902, a user selects products for purchase. In step 904, a merchant electronic cash register (ECR) records product identifiers in a basket total. As shown in box 906, a basket of 10 items for a basket total of $11.25 is shown where five items of product X at a price of $1.50 each and five items of product Y at a price of $0.75 each were purchased. In step 908, the ECR sends the product identifiers and purchase total to distribution channel 108.

In step 910, a user presents a portable device 110 to distribution channel 108 for a payment and/or loyalty transaction.

In step 912, a loyalty application compares the product identifiers, the purchase value, and/or available incentives for portable device 110. As shown in box 914, an incentive #1 of a $1 off a purchase of five units of product X is determined and combining this incentive with other incentives is allowed. As shown in box 916, an incentive #2 of $0.20 off a purchase of product Y and is determined no combining is allowed. In box 918, an incentive #3 of 75 cents off the purchase of two more units of product X is determined and combining is allowed.

In step 920, the loyalty application determines if the purchase qualifies for an incentive. In step 922, if the purchase does not qualify for an incentive, the distribution channel 108 sends a message to the ECR that no incentives apply to the purchase.

In this case, the purchase does qualify for the incentive, and in step 924, the loyalty application checks loyalty program parameters and calculates a value for the incentive redemptions. As shown in box 926, the redemption value of incentive #1 equals $1, the redemption value of incentive #2 equals $1 and the redemption value of incentive #3 equals $0.75. Thus, incentive #1 and incentive #2 have the same redemption value, which is greater than the redemption value of incentive #3. Incentive #1 and incentive #2 are most valuable, but are also equal. Thus, other factors may be used to determine which incentive is the most valuable. As shown, in one embodiment, the expiration of incentive #1 is Jun. 30, 2003, and the expiration of incentive #2 is Jun. 1, 2003. Thus, Jun. 1, 2003 is earlier than Jun. 30, 2003 and thus it is determined that incentive #2 is the most valuable because it will expire the soonest.

In step 928, the loyalty application determines if the highest value incentive allows combining. In this case, the highest value award does not allow combining and thus determining if other incentives can be combined with the highest value incentive is not performed.

In step 930, the loyalty application sends a calculated incentive value to the ECR for subtraction from the basket total. The basket total of $11.25 is discounted by $1 for a new total of $10.25. In step 932, the ECR recalculates the basket total and the new basket total is displayed to a cashier.

While the present invention has been described using a particular combination of hardware and software implemented in the form of control logic, it should be recognized that other combinations of hardware and software are also within the scope of the present invention. The present invention may be implemented only in hardware, or only in software, or using combinations thereof.

It should be understood that while the foregoing description with respect to different embodiments is provided in the context of a loyalty program, a person of ordinary skill in the art will know and appreciate how to deploy the present invention in other applications or context where concurrent product based incentives may be desirable.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

1. A method for determining one or more incentives to apply to a transaction, the method comprising:
determining a plurality of incentives that are eligible for application to the transaction, the eligibility based on at least one product;
determining one or more incentives from the plurality of incentives to apply to the transaction; and
applying the determined one or more incentives to the transaction.

2. The method of claim 1, wherein the at least one product is associated with a product identifier that is used to determine the plurality of incentives.

3. The method of claim 1, further comprising:
communicating with a portable device to determine portable device information;
wherein determining the plurality of incentives comprises using the portable device information to determine the plurality of incentives eligible for application to the transaction.

4. The method of claim 3, wherein determining the one or more incentives comprises using the determined portable device information to determine the one or more incentives.

5. The method of claim 3, wherein using the determined portable device information comprises comparing the portable device information with information associated with the plurality of incentives to determine the plurality of incentives.

6. The method of claim 3, further comprising updating the portable device information in the portable device to indicate that the determined one or more incentives have been applied to the transaction.

7. The method of claim 1, wherein determining the one or more incentives comprises determining information for applying the determined one or more incentives; and
using the information to determine how the determined one or more incentives are to be applied to the transaction.

8. The method of claim 7, wherein the information comprises information indicating if an incentive is combinable with another incentive.

9. The method of claim 7, wherein determining the one or more incentives comprises comparing the information for applying the determined one or more incentives with transaction details for the transaction to determine the one or more incentives.

10. The method of claim 1, further comprising calculating a total value for the transaction, wherein a collective value of the one or more incentives when applied is equal to or less than the total value.

11. The method of claim 10, wherein applying the determined one or more incentives comprises calculating a new total value based on the total value for the transaction less the value of the one or more incentives.

12. A method for managing incentives in connection with a loyalty transaction, the method comprising:
determining a plurality of incentives that are eligible for the loyalty transaction, the eligibility determined based on at least one product;
calculating an incentive value for each of the plurality of incentives;
determining one or more incentives from the plurality of incentives to apply to the loyalty transaction based on the calculated incentive values for each of the plurality of incentives; and
applying the determined one or more incentives to the loyalty transaction.

13. The method of claim 12, wherein the at least one product is associated with a product identifier that is used to determine the plurality of incentives.

14. The method of claim 12, wherein determining one or more incentives comprises:
determining a highest incentive value from the calculated incentive values; and
wherein applying the determined one or more incentives comprises applying an incentive with the highest incentive value.

15. The method of claim 14, further comprising:
determining if the incentive with the highest incentive value allows the incentive to be combined with other incentives; and
if the incentive does allow for combining, determining another incentive to apply to the loyalty transaction in addition to the incentive with the highest value.

16. The method of claim 12, further comprising:
calculating a total value for the loyalty transaction, wherein a collective value of the one or more incentives is equal to or less than the calculated total value.

17. The method of claim 16, wherein applying the determined one or more incentives comprising calculating a new total value from the total value based on the determined one or more incentives.

18. The method of claim 17, further comprising outputting the new total value.

19. The method of claim 12, further comprising:
communicating with a portable device to determine portable device information;
wherein determining the plurality of incentives comprises using the portable device information to determine the plurality of incentives that are eligible for the loyalty transaction.

20. The method of claim 19, further comprising updating portable device information in the portable device to indicate that the one or more incentives have been applied to the loyalty transaction.

21. A method for determining one or more incentives to apply to a loyalty transaction, the method comprising:
communicating with a portable device to conduct the loyalty transaction, the loyalty transaction involving at least one product having a product identifier;
determining portable device information for the portable device;
determining a plurality of incentives that are eligible for the loyalty transaction, the eligible incentives determined based on the product identifier and the portable device information;
determining one or more incentives from the plurality of incentives to apply to the loyalty transaction; and
applying the determined one or more incentives to the loyalty transaction.

22. The method of claim 21, wherein determining the one or more incentives comprises determining information for applying the one or more incentives; and
using the information for applying to determine how the one or more incentives are to be applied to the loyalty transaction.

23. The method of claim 22, wherein the information for applying comprises information indicating if an incentive is combinable with another incentive.

24. The method of claim 22, wherein the information for applying comprises information indicating that an incentive having a nearest expiration date is to be applied.

25. The method of claim 22, wherein the information for applying comprises information indicating that a user preference is to be used to determine how to apply the one or more incentives.

26. The method of claim 22, wherein determining the one or more incentives comprises comparing the information for applying with transaction details for the loyalty transaction to determine the one or more incentives.

27. The method of claim 21, further comprising calculating a total value for the loyalty transaction, wherein a collective value of the one or more incentives when applied is equal to or less than the total value.

28. The method of claim 27, wherein applying the determined one or more incentives comprises calculating a new total value for the loyalty transaction based on the one or more incentives.

29. The method of claim 21, further comprising updating information in the portable device to indicate that the one or more incentives have been applied to the transaction.

30. A method for managing a plurality of incentives, the method comprising:
determining information for the plurality of incentives, the information for each incentive including a product identifier;
determining one or more rules for applying incentives if two or more incentives in the plurality of incentives are applicable for a loyalty transaction; and
sending the information and the one or more rules to one or more distribution channels, wherein the information including the product identifier is usable to determine two or more eligible incentives from the plurality of incentives for the loyalty transaction and the one or more rules are usable to determine one or more incentives from the two or more eligible incentives that are applicable for the loyalty transaction.

31. The method of claim 30, wherein the one or more rules comprise values that are compared to at least one of portable device information and information from the loyalty transaction to determine the one or more incentives that are applicable.

32. The method of claim 30, wherein the one or more rules include a rule specifying if an incentive may be combined with other incentives in the two or more eligible incentives.

33. The method of claim 30, wherein the one or more rules include a rule specifying if one incentive should override another incentive in the two or more eligible incentives.

34. The method of claim 30, wherein the one or more rules include a rule specifying that a highest value incentive in the two or more eligible incentives should be applied.

35. The method of claim 30, wherein the one or more rules include a rule specifying which incentive in the two or more eligible incentives to apply based on a product identifier.

36. The method of claim 30, wherein the one or more rules include a rule specifying a user preference that is to be used in determining the one or more incentives applicable for the loyalty transaction.

37. A method for determining one or more incentives to apply to a loyalty transaction, the method comprising:
using a portable device in a loyalty transaction for at least one product associated with a product identifier;
determining loyalty program information for a plurality of loyalty programs;
determining portable device information for the portable device;
determining transaction details for the loyalty transaction;
determining one or more incentives from a plurality of incentives to apply to the loyalty transaction based on at least one of the loyalty program information, portable device information, product identifier, and transaction details, wherein the plurality of incentives are associated with the product identifier; and
applying the determined one or more incentives to the loyalty transaction.

38. The method of claim 37, wherein the loyalty program information comprises parameters that specify rules useable in determining the one or more incentives.

39. The method of claim 38, wherein the rules comprise at least one of a rule based on a monetary value, a rule based on the product identifier and a user selection, a rule based on an expiration date, and a rule based on if an incentive in the plurality of incentives is combinable.

40. The method of claim 37, wherein the portable device information comprises information specific to the portable device, wherein determining the one or more incentives comprises using the information specific to the portable device to determine the one or more incentives.

41. The method of claim 37, wherein the transaction details comprise information specific to the loyalty transaction, wherein determining the one or more incentives comprises using the information specific to the loyalty transaction to determine the one or more incentives.

42. A device for determining one or more incentives to apply to a loyalty transaction, the device comprising:
a communicator configured to receive a request to process a loyalty transaction involving at least one product;
a program determiner configured to determine a plurality of incentives that are eligible for application to the loyalty transaction, the eligibility based on the at least one product;
an incentive selector configured to select one or more incentives from the plurality of incentives to apply to the loyalty transaction; and
an incentive applier configured to apply the determined one or more incentives to the loyalty transaction.

43. The device of claim 42, wherein the communicator is configured to communicate with a portable device to determine portable device information, the portable device information useable to determine the plurality of incentives or the selected one or more incentives.

44. The device of claim 42, wherein the communicator is configured to determine transaction details, the transaction details useable to determine the plurality of incentives or the selected one or more incentives.

45. The device of claim 42, further comprising an output configured to output a new total for the loyalty transaction based on the applied one or more incentives.

46. The device of claim 42, further comprising a database configured to store information for the plurality of loyalty programs, the information useable to determine the plurality of incentives or the selected one or more incentives.

47. The device of claim 42, wherein the communicator is configured to cause update information for the loyalty transaction to be written to a portable device.

48. A system for determining one or more incentives to apply to a loyalty transaction, the system comprising:
one or more portable devices, each portable device including portable device information; and
one or more distribution channels, at least one distribution channel comprising:
a communicator configured to communicate with a portable device in the one or more portable devices for a loyalty transaction involving at least one product and to determine portable device information associated with the portable device;
an incentive selector configured to determine one or more incentives from a plurality of incentives associated with the at least one product to apply to the loyalty transaction, the one or more incentives determined based on the at least one product and the portable device information; and
an incentive applier configured to apply the determined one or more incentives to the loyalty transaction.

49. The system of claim 48, wherein the at least one distribution channel further comprises a program determiner configured to determine the plurality of incentives associated with the at least one product.

50. The system of claim 48, further comprising a host configured to download information relating to the plurality of incentives to at least one distribution channel, wherein the information is useable to determine the one or more incentives.

51. The system of claim 50, wherein the information relating to the plurality of incentives comprises at least one of a rule based on a monetary value, a ruled based on the at least one product and a user selection, a rule based on an expiration date, and a rule based on if an incentive in the plurality of incentives is combinable.
